(19) United States
(12) Patent Application Publication
(10) Pub. No.: US 2010/0005484 A1
(43) Pub. Date: Jan. 7, 2010

(54) Point of Deployment Module to Retrofit Upstream Transmission Capability to an Audiovisual Device

(75) Inventors: Brant Candelore, San Diego, CA (US); William G. Bennett, Vista, CA (US); James R. Milne, Ramona, CA (US)

Correspondence Address: BLAKELY SOKOLOFF TAYLOR & ZAFMAN LLP, 1279 OAKMEAD PARKWAY, SUNNYVALE, CA, 94085-4040, US

(73) Assignees: SONY CORPORATION, Tokyo (JP); SONY ELECTRONICS INC., Park Ridge, NJ (US)

(21) Appl. No.: 12/060,008

(22) Filed: Mar. 31, 2008

(51) Int. Cl. H04N 7/167; H04N 7/173

(52) U.S. Cl. 725/31; 725/127

(57) ABSTRACT

A point of deployment module includes a HOST-POD interface for connecting the point of deployment module to a digital audiovisual receiver. A first connector on the point of deployment module may receive a downstream signal from a service provider. A second connector on the point of deployment module may provide a signal to a tuner of the digital audiovisual receiver. An out of band transmitter in the point of deployment module provides an upstream signal to the service provider. A combiner may be coupled to the first connector, the second connector, and the out of band transmitter. The combiner may transfer the downstream signal from the first connector to the second connector and may transfer the upstream signal from the out of band transmitter to the first connector. The point of deployment module may include a receptacle for a second point of deployment module connected to the HOST-POD interface.

### BACKGROUND

1. Field

Embodiments of the invention relate to the field of digital television; and more specifically, to retrofitting digital television receivers with an upstream signaling capability.

2. Background

Audiovisual devices such as televisions may receive TV programs from over-the-air broadcasters or pay-TV service providers such as from satellite, telco and cable providers. These services typically provide a number of simultaneous programs from which a viewer may select. In view of the number of program offerings, the viewer is often able to access an electronic program guide that may be used to display information about available programs and to select a program.

The audiovisual device may include one or more tuners that allow reception of program content from a service provider without the need for an external set top box (STB) to provide the tuning function. Including the tuning function within the audiovisual device reduces clutter by eliminating the set top box and the associated cabling, reduces the number of remote controls, simplifies setup by requiring only a single connection of the cable to the audiovisual device, and allows the viewer to select over-the-air or pay-tv programming using the controls of the audiovisual device. This may provide a more cohesive viewing environment for the viewer than having to use a second interface for tuning provided by a set top box. The audiovisual device may provide superior decoding of a compressed digital program and thus better picture quality. The audiovisual device can also provide advanced features such as picture-in-picture (PIP) that require tuning more than one program simultaneously.

A service provider may provide a subscription service which broadcasts content on the cable connected to the audiovisual device. However, some program content may be interactive requiring an active back-channel for viewing or for reportback. For example, with a back-channel, the user can request that the cable or telco service provider provide video-on-demand (VOD) content on the cable connected to the audiovisual device for which the viewer may pay an additional fee to view. VOD could also be offered as a subscription. The back-channel can not only allow for the provisioning of a VOD program but also allows for trick play operation such as fast forward, pause, slow motion, etc.

Another type of content that may be possible with a back-channel is Impulse Pay-per-View (IPPV). With IPPV, the program is broadcast speculatively, and the audio-visual device can tune to the program if allowed, e.g. if the account is in good standing and sufficient credit is available. Later, a reportback to the headend is made using the back-channel to signal that a program was watched. The customer is then billed accordingly. Program content is typically encrypted to prevent viewing by those who have not made or will make the necessary payment (for subscription and IPPV content). With VOD, the service provider intrinsically knows that a consumer has requested content. Encryption also safeguards the content from being copied and redistributed, e.g. on the Internet. A set top box may be used to decrypt the interactive VOD or IPPV content, but this takes away the advantages provided by the internal tuner of the audiovisual device.

The audiovisual device may provide a connection or slot for a CableCARD™ device (also known as a point of deployment (POD) module). A service provider may provide a CableCARD™ device that can be connected to the audiovisual device to decrypt interactive content received using the tuner included in an audiovisual device. Use of a CableCARD™ maintains the advantages provided by the internal tuner of the audiovisual device when encrypted premium content is to be received.

It should be noted that telco providers may adopt the same or similar technology as CableCARD. And while the discussion herein discusses cable, it could apply equally well to telco providers of pay-TV services. One difference, however, is that with telco services, all the content may be on-demand. Likewise, over-the-air broadcasters may offer pay services along with free programming. They may adopt the same or similar technology as well.

It should also be noted that the term “out-of-band” channel is used. The out-of-band channel is frequency or mode of transmission separate from that used to deliver content. In some cases, downstream signaling can be sent in-band, e.g. the sending of Entitlement Management Messages (EMMs) in-band with the content. In which case, the out-of-band channel may only be used for upstream communications. The upstream communication is also described as a “return channel”. Impulse Pay-per-View (IPPV) is an example of a service for which return channel is required but not necessarily a separate downstream channel if communication, as mentioned before, can be managed in-band. The out-of-band channel could be phone or Ethernet as well as the aforementioned separate frequency or mode of transmission on the media that delivers the content.

A cable plant has a limited amount of bandwidth which determines the number of programs that can be delivered by the service provider. High definition programs take significantly more bandwidth than standard definition programs. The desire to provide more programs and particularly more high definition programs has caused service providers to seek ways of allocating the limited bandwidth of their cable connections more effectively.

Cable service providers may operate a hybrid fiber-coax (HFC) network in which a high capacity optical fiber link supplies programming to a large number of fiber optic nodes, each of which serves anywhere from 25 to 2000 homes with a lower bandwidth coaxial cable connection. It is likely that a number of programs provided on the coaxial cable connection are not being viewed at any given time.

Cable service providers may use switched video (SD) to provide certain subscription-based, previously non-interactive, programs only when a viewer actually tunes to the program thus reducing the bandwidth required to deliver programming. When a viewer tunes to a program that is delivered as switched video, an upstream transmission is sent to the fiber optic node on the coaxial cable connection to indicate that a viewer has tuned that program and it therefore needs to be provisioned on the cable. Unlike with IPPV or VOD there is no additional payment involved. Ideally SD is transparent to the viewer since the viewer should perceive the SD programming as being identical to other non-interactive programming provided by the service provider. However, since an upstream transmission is required to receive SD programming, a set top box with a back-channel may be required even to receive basic cable programming, again taking away the advantages provided by the internal tuner of the audiovisual device.

It would be desirable to provide a device that enables upstream transmissions from an audiovisual device without the need for a set top box to retain the benefits of using the internal tuner of the audiovisual device while enabling services such as switched video, VOD, and IPPV.

### SUMMARY

A point of deployment module includes a HOST-POD interface for connecting the point of deployment module to a digital audiovisual receiver. A first connector on the point of deployment module may receive a downstream signal from a service provider. A second connector on the point of deployment module may provide a signal to a tuner of the digital audiovisual receiver. An out of band transmitter in the point of deployment module provides an upstream signal to the service provider. A combiner may be coupled to the first connector, the second connector, and the out of band transmitter. The combiner may transfer the downstream signal from the first connector to the second connector and may transfer the upstream signal from the out of band transmitter to the first connector. The point of deployment module may include a receptacle for a second point of deployment module connected to the HOST-POD interface.

Other features and advantages of the present invention will be apparent from the accompanying drawings and from the detailed description that follows below.

### BRIEF DESCRIPTION OF THE DRAWINGS

The invention may best be understood by referring to the following description and accompanying drawings that are used to illustrate embodiments of the invention by way of example and not limitation. In the drawings, in which like reference numerals indicate similar elements:

FIG. 1 is a pictorial view of an exemplary audiovisual receiver with a point of deployment module that embodies the invention.

FIG. 2 is a pictorial view of a point of deployment module that embodies the invention.

FIG. 3 is a block diagram for a point of deployment module that embodies the invention.

FIG. 4 is a block diagram for another point of deployment module that embodies the invention.

FIG. 5 is a pictorial view of another point of deployment module that embodies the invention.

FIG. 6 is a block diagram for another point of deployment module that embodies the invention.

### DETAILED DESCRIPTION

In the following description, numerous specific details are set forth. However, it is understood that embodiments of the invention may be practiced without these specific details. In other instances, well-known circuits, structures and techniques have not been shown in detail in order not to obscure the understanding of this description.

As used herein, the terms “a” or “an” shall mean one or more than one. The term “plurality” shall mean two or more than two. The term “another” is defined as a second or more. The terms “including” and/or “having” are open ended (e.g., comprising). The term “or” as used herein is to be interpreted as inclusive or meaning any one or any combination. Therefore, “A, B or C” means “any of the following: A; B; C; A and B; A and C; B and C; A, B and C”. An exception to this definition will occur only when a combination of elements, functions, steps or acts are in some way inherently mutually exclusive.

Reference throughout this document to “one embodiment”, “certain embodiments”, “an embodiment” or similar term means that a particular feature, structure, or characteristic described in connection with the embodiment is included in at least one embodiment of the present invention. Thus, the appearances of such phrases or in various places throughout this specification are not necessarily all referring to the same embodiment. Furthermore, the particular features, structures, or characteristics may be combined in any suitable manner on one or more embodiments without limitation.

### Exemplary Embodiments

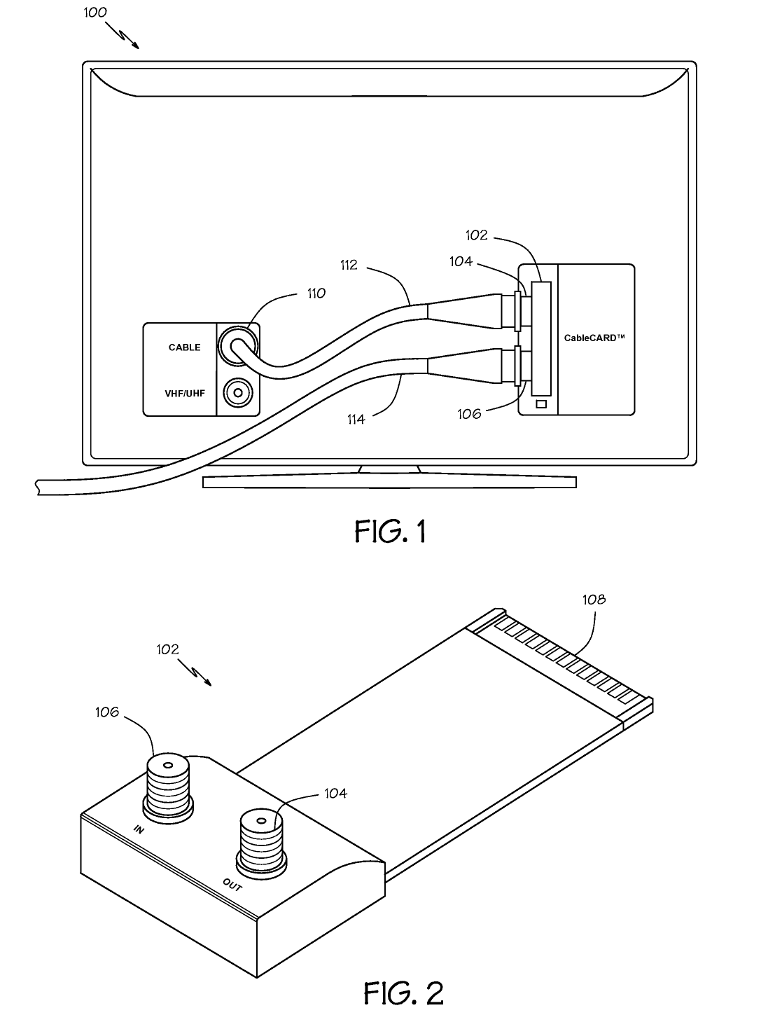

FIG. 1 shows an exemplary audiovisual receiver 100 with a point of deployment module 102 or CableCARD™ that embodies the invention. The point of deployment module 102 includes a first connector 106 to receive a downstream signal from a service provider which may be provided on a first coaxial cable 114. The point of deployment module 102 further includes a second connector 104 to provide a signal to the digital audiovisual receiver 100. The second connector 104 may be connected to a connector 110 on the audiovisual receiver 100 by a second coaxial cable 112 to provide signal to a tuner in the audiovisual receiver. The second coaxial cable 112 may include both program frequencies and out-of-band frequencies need to communicate with the CableCARD in a downstream manner. Alternatively, the CableCARD equipped with an out-of-band tuner can receive those signals directly and block them from being sent across the second coaxial cable 112. This might have an advantage of eliminating a source of noise for the in-band tuner in the audiovisual device.

FIG. 2 shows the exemplary point of deployment module 102 apart from the audiovisual receiver. The point of deployment module includes a HOST-POD interface 108 for connecting the point of deployment module to the digital audiovisual receiver 100. As may be seen in FIG. 2, the first and second connectors may be provided on an extended portion of the point of deployment module 102 that remains outside of the slot provided by the audiovisual receiver to receive the point of deployment module. In other embodiments the connectors may be mounted on other surfaces of the extended portion in different orientations or they may be provided on cables. In one embodiment, the second connector may be on a cable of sufficient length to be directly connected to the connector 110 on the audiovisual receiver 100 without the need for the second coaxial cable 112 shown in FIG. 1.

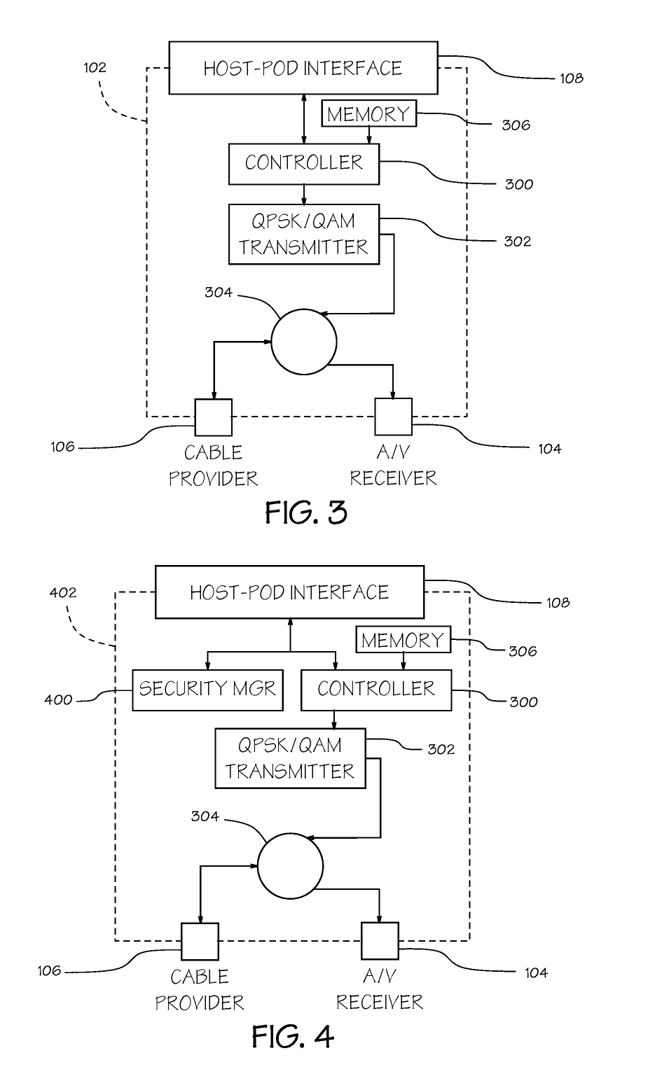

FIG. 3 shows an exemplary block diagram for the point of deployment module 102 shown in FIGS. 1 and 2 that embodies the invention. The point of deployment module 102 includes an out of band transmitter 302 to provide an upstream signal to the service provider. The out of band transmitter 302 may be quadrature phase shift keying/quadrature amplitude modulation (QPSK/QAM) transmitter. The point of deployment module 102 can provide upstream transmitter support for out-of-band signaling that is otherwise lacking in the audiovisual device 100.

A combiner 304 is coupled to the first connector 106, the second connector 104, and the out of band transmitter 302 to transfer the downstream signal from the first connector to the second connector and to transfer the upstream signal from the out of band transmitter to the first connector. The combiner 304 may be a duplexer, which is a three-port combiner. The combiner 304 may include one or more filters that isolates the second connector 104 from the out of band transmitter 302 to block out of band transmissions from reaching the tuner of the audiovisual receiver while allowing the downstream signal from the first connector to pass through to the tuner. The combiner filters may reject the out of band transmit frequency and pass the downstream receive frequency to the second connector 104. Additionally or alternatively the combiner filters may reject the downstream receive frequency and pass the out of band transmit frequency from the out of band transmitter 302. It should be noted that the combiner may be provided externally to the point of deployment module 102. In this configuration, the module may only have the first connector.

The point of deployment module 102 may include a controller 300 coupled to the HOST-POD interface 108 and the out of band transmitter 302. The adapter may also include memory 306 for the controller 300. The memory may consist of any combination of non-volatile storage that provides random access memory (RAM). The memory 306 may store the program executed by the controller 300 and/or may provide scratch pad memory. The controller 300 may receive tuning information from the HOST-POD interface 108 and generate signal information to enable delivery of switched video services. The controller 300 may provide the signal information to the out of band transmitter 302, which may provide the signal information to the service provider as an upstream signal. The controller 300 may further provide channel information to the HOST-POD interface 108 to enable tuning of switched video services by the audiovisual receiver 100.

FIG. 4 shows a block diagram for another point of deployment module 402 that embodies the invention. This point of deployment module may have a physical configuration similar to the module 102 shown in FIGS. 1 and 2. The point of deployment module 402 may further include a security manager 400 which decrypts the signal using conditional access and re-encrypts for copy protections across the HOST-POD interface 108. The security manager 400 provides signals to the HOST-POD interface 108 to enable delivery of encrypted video services by the audiovisual receiver 100.

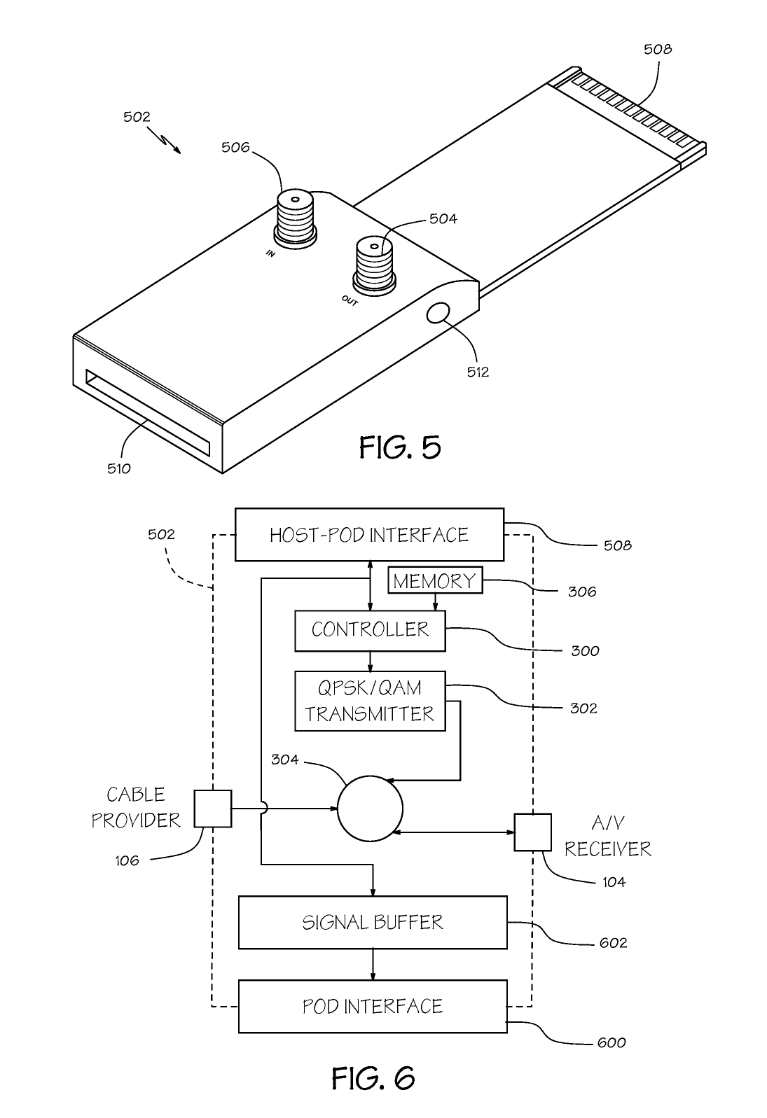

FIG. 5 shows another exemplary point of deployment module 502 that embodies the invention. The point of deployment module 502 includes a HOST-POD interface 508 for connecting the point of deployment module to the digital audiovisual receiver 100. First 506 and second 504 connectors may be provided on an extended portion of the point of deployment module 502 that remains outside of the slot provided by the audiovisual receiver. In this embodiment, the extended portion of the point of deployment module 502 may provide a receptacle 510 to receive a second point of deployment module such as a module that provides services for receipt of encrypted content. The extended portion may provide mechanical support for the second point of deployment module. The extended portion may be hinged 512 in order to bend at an angle to the audiovisual receiver 100. Alternatively, it is possible for the point of deployment module 502 to be partially made of flex cable to that it may be bent on exiting the audiovisual receiver 100.

FIG. 6 shows a block diagram for the point of deployment module 402 shown in FIG. 5. This point of deployment module further includes a POD interface 600 coupled to the HOST-POD interface 508. The POD interface permits use of a second point of deployment module by the audiovisual receiver 100 to enable delivery of encrypted video services. The second point of deployment module is plugged into to a POD interface connector 600. The host-pod interface 108 of the first point of deployment module 502 plugs into the audiovisual device 100. The POD interface connector 600 may remain outside the audiovisual device 100. The first point of deployment module 502 may include a signal buffer 602 to buffer signals to and from the second point of deployment module. The signal buffer 602 may be needed since the trace lengths will be extended since the second point of deployment module does not plug directly into the audiovisual device 100, but rather into the first point of deployment module 502 at the POD interface connector 600. The first point of deployment module 502 may provide upstream transmitter support for out-of-band signaling that is otherwise lacking in the audiovisual device 100.

While certain exemplary embodiments have been described and shown in the accompanying drawings, it is to be understood that such embodiments are merely illustrative of and not restrictive on the broad invention, and that this invention is not limited to the specific constructions and arrangements shown and described, since various other modifications may occur to those of ordinary skill in the art. The description is thus to be regarded as illustrative instead of limiting.

What is claimed is:

1. A point of deployment module comprising:
a HOST-POD interface for connecting the point of deployment module to a digital audiovisual receiver; and
an out of band transmitter to provide an upstream signal to the service provider.

2. The point of deployment module of claim 1, further comprising:
a first connector to receive a downstream signal from the service provider;
a second connector to provide a signal to a tuner of the digital audiovisual receiver; and
a combiner coupled to the first connector, the second connector, and the out of band transmitter, the combiner to transfer the downstream signal from the first connector to the second connector and to transfer the upstream signal from the out of band transmitter to the first connector.

3. The point of deployment module of claim 1, further comprising a controller coupled to the HOST-POD interface.

4. The point of deployment module of claim 3, wherein the controller is further to provide channel information to the HOST-POD interface to enable tuning of switched video services.

5. The point of deployment module of claim 1, further comprising a POD interface coupled to the HOST-POD interface, the POD interface for connecting to a second point of deployment module that enables delivery of encrypted video services.

6. The point of deployment module of claim 1, further comprising a security manager coupled to the HOST-POD interface, the security manager to provide signals to the HOST-POD interface to enable delivery of encrypted video services.

7. The point of deployment module of claim 1, wherein the out of band transmitter is a quadrature phase shift keying/quadrature amplitude modulation (QPSK/QAM) transmitter.

8. A method for enabling delivery of switched video services comprising:
connecting a point of deployment module to a HOST-POD interface of a digital audiovisual receiver;
receiving a downstream signal from a service provider;
providing a signal to a tuner of the digital audiovisual receiver;
connecting an out of band transmitter to the HOST-POD interface through the point of deployment module; and
providing an upstream signal from the out of band transmitter to the service provider, the upstream signal enabling delivery of switched video services.

9. The method of claim 8, further comprising:
receiving tuning information from the HOST-POD interface;
generating signal information to enable delivery of switched video services; and
providing the signal information to the out of band transmitter.

10. The method of claim 9, further comprising providing channel information to the HOST-POD interface to enable tuning of switched video services by the digital audiovisual receiver.

11. The method of claim 8, further comprising providing a POD interface coupled to the HOST-POD interface, the POD interface for connecting to a second point of deployment module that enables delivery of encrypted video services.

12. The method of claim 8, further comprising providing signals to the HOST-POD interface to enable delivery of encrypted video services.

13. The method of claim 8, wherein the out of band transmitter is a quadrature phase shift keying/quadrature amplitude modulation (QPSK/QAM) transmitter.

14. A point of deployment module comprising:
a HOST-POD interface for connecting the point of deployment module to a digital audiovisual receiver;
means for receiving a downstream signal from a service provider on a first connector on the point of deployment module;
means for providing a signal to a tuner of the digital audiovisual receiver on a second connector on the point of deployment module;
means for providing an upstream signal from an out of band transmitter in the point of deployment module to the second connector, the upstream signal enabling delivery of switched video services.

15. The point of deployment module of claim 14, further comprising:
means for receiving tuning information from the HOST-POD interface;
means for generating signal information to enable delivery of switched video services; and
means for providing the signal information to the out of band transmitter.

16. The point of deployment module of claim 15, further comprising means for providing channel information to the HOST-POD interface to enable tuning of switched video services by the digital audiovisual receiver.

17. The point of deployment module of claim 14, further comprising means for connecting to a second point of deployment module that enables delivery of encrypted video services.

18. The point of deployment module of claim 14, further comprising means for providing signals to the HOST-POD interface to enable delivery of encrypted video services.

19. The point of deployment module of claim 14, wherein the out of band transmitter is a quadrature phase shift keying/quadrature amplitude modulation (QPSK/QAM) transmitter.
